(19) United States
(12) Patent Application Publication
(10) Pub. No.: US 2025/0139561 A1
(43) Pub. Date: May 1, 2025

(54) SUSTAINABLE AUTOSCALING WORKFLOW

(71) Applicant: International Business Machines Corporation, Armonk, NY (US)

(72) Inventors: Munish Chahal, Noida (IN); Venkata Vinay Kumar Parisa, Secunderabad (IN); Dharma Teja Atluri, Hyderabad (IN); Vivek Singh, Ghaziabad (IN); Santanu Ghosh, Kolkata (IN)

(21) Appl. No.: 18/496,290

(22) Filed: Oct. 27, 2023

(51) Int. Cl. G06Q 10/0639

(52) U.S. Cl. CPC G06Q 10/06393

(57) ABSTRACT

One embodiment provides a method including continuously monitoring, by a computing device, carbon emissions for establishing software application priority for autoscaling. The carbon emissions are utilized as an observability metric while leveraging business criticality and burst capacity to define the software application execution scenario. A first sustainability threshold for the software application and a second sustainability threshold for each of multiple business units are identified for leveraging a carbon footprint based on the business criticality and strategic importance for multiple software applications including the software application in an enterprise application portfolio. The software application execution is autoscaled based on the first sustainability threshold and the second sustainability threshold.

### BACKGROUND

The field of embodiments of the present invention relates to using carbon emissions for a software application and enterprise sustainability thresholds for autoscaling resources.

Transitioning to a net-zero world is one of the greatest challenges humankind has faced. A growing coalition of countries, cities, businesses, and other institutions are pledging to get to net-zero emissions. More than seventy countries, including the biggest polluters—China, the United States, and the European Union—have set a net-zero target, covering about 76% of global emissions.

Over 1200 companies have put in place science-based targets in line with net-zero, and more than 1000 cities, over 1000 education institutions, and over 400 financial institutions have joined the “Race to Zero,” pledging to take rigorous, immediate action to halve global emissions by 2030.

Energy and utilities amount to 40% of global CO₂ emissions. Most of the CO₂ emissions are from electricity generation, mainly due to the combustion of fossil fuels to generate the heat needed to run steam turbines. Worldwide, it is estimated that data centers consume about 3% of the global electricity supply and account for about 2% of total greenhouse gas (GHG) emissions. That is about the same as the entire airline industry. It is also estimated that this will increase by 5%-7% every year as more and more traditional businesses are shifting to have a digital presence.

### SUMMARY

Embodiments relate to using carbon emissions for a software application and enterprise sustainability thresholds for autoscaling resources. One embodiment provides a method including continuously monitoring, by a computing device, carbon emissions for establishing software application priority for autoscaling. The carbon emissions are utilized as an observability metric while leveraging business criticality and burst capacity to define the software application execution scenario. A first sustainability threshold for the software application and a second sustainability threshold for each of multiple business units are identified for leveraging a carbon footprint based on the business criticality and strategic importance for multiple software applications including the software application in an enterprise application portfolio. The software application execution is autoscaled based on the first sustainability threshold and the second sustainability threshold.

These and other features, aspects and advantages of the present embodiments will become understood with reference to the following description, appended claims and accompanying figures.

### BRIEF DESCRIPTION OF THE DRAWINGS

FIG. 1 illustrates a high-level value driver mapping for telecommunications companies;

FIG. 2A illustrates a table for numeric conversion of high, medium, and low distribution, according to some embodiments;

FIG. 2B illustrates business-value frequency distribution as generated by an algorithm, according to some embodiments;

FIG. 2C illustrates a table for strategic value frequency distribution, according to some embodiments;

FIG. 3A illustrates a table for derived application business values, according to some embodiments;

FIG. 3B illustrates a table for derived application strategic values, according to some embodiments;

FIG. 4 illustrates a table for a burst value map, according to some embodiments;

FIG. 5 illustrates a table for scaling permitted values, according to some embodiments;

FIG. 6 illustrates a table for scale limits, according to some embodiments;

FIG. 7 illustrates an example table for burst level threshold, according to some embodiments;

FIG. 8 illustrates a table for a burst value map, according to some embodiments;

FIG. 9 illustrates an example table for alignment of applications burst level based on decision rules, according to some embodiments;

FIG. 10 illustrates an example table for application burst level threshold scale, according to some embodiments;

FIG. 11 illustrates an example table for application burst level threshold, according to some embodiments;

FIG. 12 illustrates an enterprise threshold limit diagram, according to some embodiments;

FIG. 13 illustrates a table for scaling permitted values for high priorities, according to some embodiments;

FIG. 14 illustrates an example table showing high priority score allocation, according to some embodiments;

FIG. 15 illustrates an example chart for applications priority access and wait queue mechanism, according to some embodiments;

FIG. 16 illustrates an example table for applications burst capacity allocation, according to some embodiments;

FIG. 17 illustrates an example table for applications compute consumption, according to some embodiments;

FIG. 18 illustrates a graph for applications compute consumption over time intervals, according to some embodiments;

FIG. 19 illustrates a table for carbon footprint (CF) limits, according to some embodiments;

FIG. 20 illustrates an example table for application carbon emission threshold, according to some embodiments;

FIG. 21 illustrates a flow diagram for a rule engine for managing maximum emission allowed at the business unit (BU) level, according to some embodiments;

FIG. 22 illustrates an example table for BU information, according to some embodiments;

FIG. 23 illustrates a table for BU total possible emission, according to some embodiments;

FIG. 24 illustrates a table for scaling boundary, according to some embodiments;

FIG. 25 illustrates an example table for BU minimum emission (British Thermal Unit (BTU)), according to some embodiments;

FIG. 26 illustrates another flow diagram for a rule engine for managing maximum emission allowed at the BU level, according to some embodiments;

FIG. 27 illustrates a flow diagram for a rule engine for managing BU level scaling limit, according to some embodiments;

FIG. 28 illustrates a process for autoscaling a software application based on carbon emissions, according to some embodiments; and

FIG. 29 illustrates an example computing environment utilized by some embodiments.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to using carbon emissions for a software application and enterprise sustainability thresholds for autoscaling resources. One embodiment provides a method including continuously monitoring, by a computing device, carbon emissions for establishing software application priority for autoscaling. The carbon emissions are utilized as an observability metric while leveraging business criticality and burst capacity to define the software application execution scenario. A first sustainability threshold for the software application and a second sustainability threshold for each of multiple business units are identified for leveraging a carbon footprint based on the business criticality and strategic importance for multiple software applications including the software application in an enterprise application portfolio. The software application execution is autoscaled based on the first sustainability threshold and the second sustainability threshold.

Enterprises today are moving their information technology (IT) workloads to the cloud to achieve their sustainability goals. Public cloud providers are providing carbon emission calculators to determine the carbon emissions associated with the cloud services. The challenge today is all approaches to achieving sustainability goals are reactive and not proactive. There are no preventive measures to identify carbon emissions on demand and alter the behavior of IT or applications. Some embodiments provide a carbon emission based decision making for autoscaling. One or more embodiments provide a mechanism for enterprise systems to control its carbon emission at three levels: software application, business unit (BU), and enterprise system. In some embodiments, autoscaling provides resiliency during distributed denial of services (DDoS) attack, which can make multiple software applications to scale up to their maximum limit during attack. One or more embodiments, however, limit DDoS attacks at a maximum approved BU or enterprise system level. Some embodiments provide regular learning ability by observing a carbon emission heat map at the software application, BU and enterprise system level and constantly calibrates a carbon emission limit at the enterprise system level as per observed trend. Further, in some embodiments, software applications are energy aware and react accordingly based on the regulation of the compute.

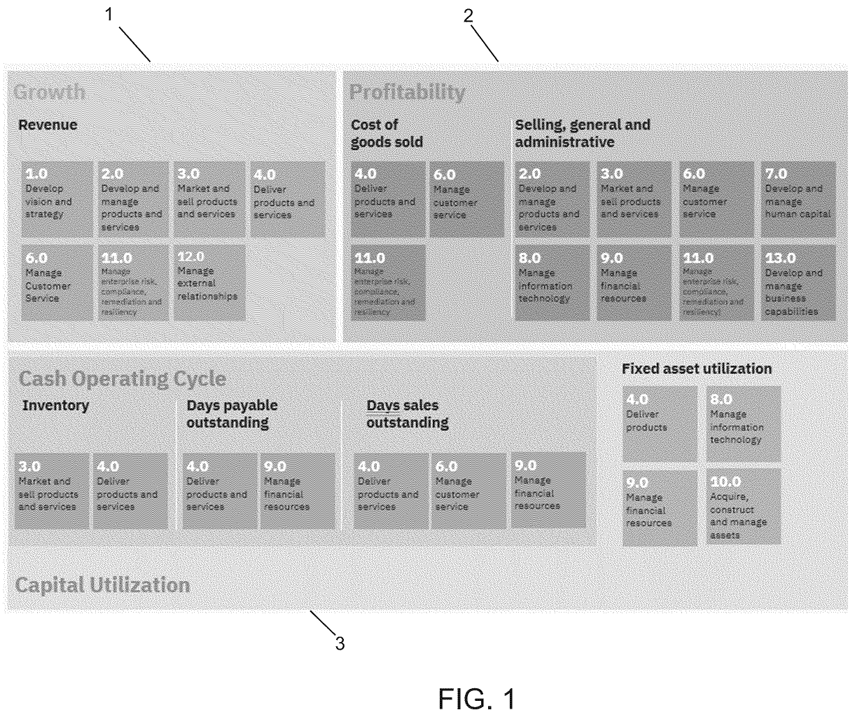

FIG. 1 illustrates a high-level value driver mapping for telecommunications companies. Chart 1 shows growth in terms of revenue, chart 2 shows profitability in terms of cost of goods sold and selling, general and administrative activities, and chart 3 shows capital utilization for cash operating cycle for inventory, days payable outstanding and days sales outstanding, along with fixed asset utilization. In some embodiments, the disclosed technology obtains business and strategic values of applications in the organization, and labels these as High, Medium, Low. In one or more embodiments, the client provides this data. In the case this data is not readily available, a consulting study is performed to obtain the data. The software applications are rated on the core value drivers, which include growth, profitability, capital utilization and cash operating cycle. The organizations software applications business value is normalized on a unitary scale. The highest business value (BV) of a software application (or App)=1, and the rest of the software applications are similarly scored.

In one or more embodiments, software applications are scored ranging from 0 to 1 and are categorized as Low, Medium and High using the following processing. For the Low range {<0.0 &&>0.3} inclusive of limits, 0.0 and 0.3; for the Medium range {<0.4 &&>0.6} inclusive of limits, 0.4 and 0.6; and for the High Range {<0.7 &&>1.0} inclusive of limits, 0.7 and 1.0. In some embodiments, the strategic value (SV) of a software application reflects the organization's future success, such as gaining a competitive advantage, improving brand reputation, or entering new markets, etc. Similarly, the SV of the software application is arrived at and categorized as H (High), M (Medium) and L (Low). In one or more embodiments, a software application may have a High BV without having a clear SV if it only addresses an immediate operational need, whereas a software application may have a High SV without having an immediate BV if it supports a long-term strategic objective that takes time to materialize. The core processes executed by companies within the industry are grouped by core value drivers and key financial performance metrics.

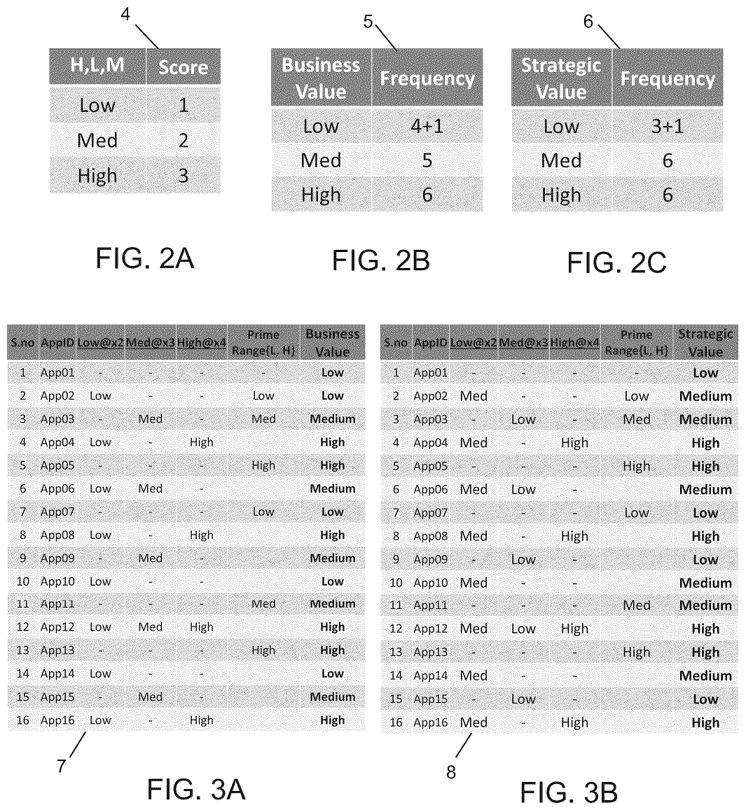

FIG. 2A illustrates a table 4 for numeric conversion of high, medium, and low distribution, according to some embodiments. FIG. 2B illustrates a table 5 for business-value frequency distribution as generated by an algorithm/process, according to some embodiments. Table 4 is shown with H, M and L scores set to 3, 2 and 1, respectively. Table 5 is shown with BVs (Low, Medium and High) and respective frequencies (4+1, 5, 6). FIG. 2C illustrates a table 6 for SV frequency distribution, according to some embodiments. The SV scores for Low, Medium and High are 3+1, 6 and 6, respectively.

FIG. 3A illustrates a table 7 for derived application business values, according to some embodiments. FIG. 3B illustrates a table 8 for derived software application SVs, according to some embodiments. In one or more embodiments, in absence of actual data, an Algorithm or process is used to generate at BV and SV of the software applications for a representative organization. In some embodiments, the BV algorithm or process utilized is as follows:

```
1: appBVal (x) = Val
      if x /4 = Integer, Val = High --- 1
      if x /3 = Integer, Val = Med --- 2
      if x/2 = Integer, Val = Low ---- 3
      else if, Val1 = PrimeVal(i) // x is prime num.
2: PrimeVal(i) = {range (Low, Medium, High) } --- (4)
  // appBVal (2) = Low, (3) = Med, (5)= High, (7) = low ...
    if Val1(i) > Val(x), appBVal (x)=Val1 ---- (5)
3: For appBVal (1) = lowest frequency (L, M, H) // which value (Low, Medium, High) has
lowest frequency and assign to app position at record 1. Table: 5 and 6, Low for 1^{st} record.
```

In one or more embodiments, the SV algorithm or process used is as follows:

$$appSVal ( x ) = appBval ( x ) // same routine except for interchange x / 2 and x / 3 Values .$$

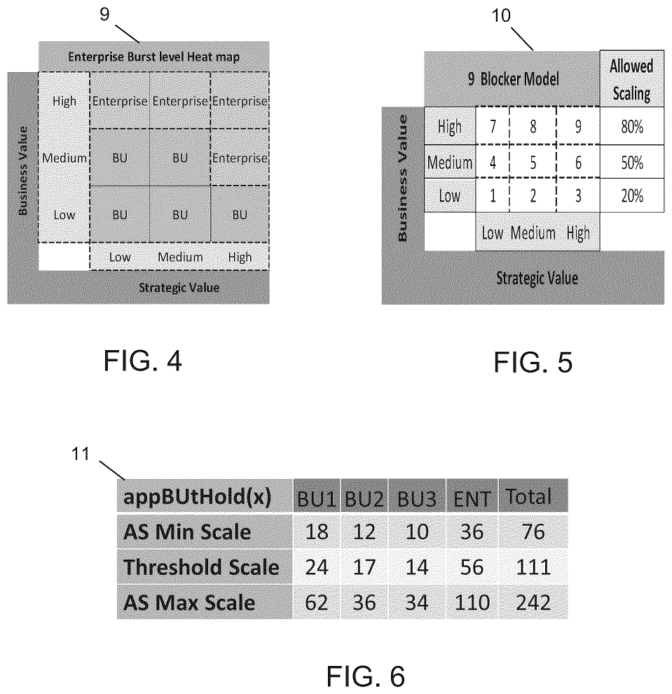

FIG. 4 illustrates a table 9 for a burst value map, according to some embodiments. In one or more embodiments, for table 9 decision rules: software application threshold (burst) level (ATL), the processing is as follows.

| | |
|---|---|
| - | App (ATL) = BU; if BV = Low . |
| - | App (ATL) = ENT (enterprise); if BV = High , |
| - | App (ATL) = ENT if BV = Med and SV= High, else App (ALT) = BU for BV = |
| | Med. |

Applications are tagged as BU or ENT based on the above-listed rules.

FIG. 5 illustrates a table 10 for scaling permitted values, according to some embodiments. In one or more embodiments, for table 10 decision rules, the algorithm or process used is as follows. Allowed Scaling (AS %):

$$AS ( x ) = ( {\sum }_{k = 1}^{3} AppBV ( k ) ) / 3 , where x = L , M , H \qquad ( Eq \text{.1} )$$

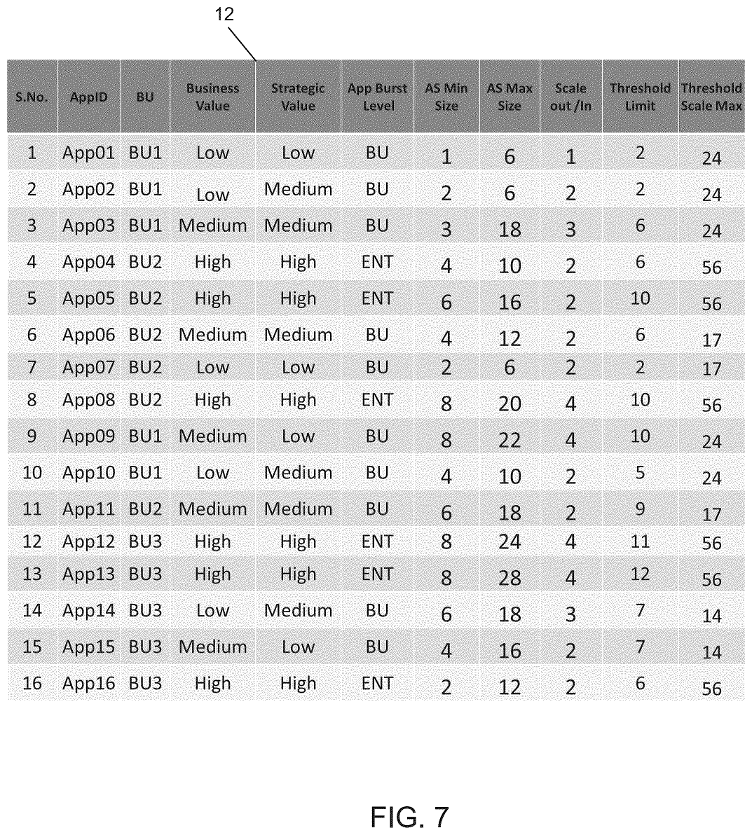

FIG. 6 illustrates a table 11 for scale limits, according to some embodiments. FIG. 7 illustrates an example table 12 for ATL, according to some embodiments. In one or more embodiments, for tables 11 and 12 decision rules, the algorithm or process used is as follows. Autoscaling minimum (Min), maximum (Max) and Scale in/out data is taken for an exemplar organization.

$$1 : AppT Hold ( i ) = [ min Size ( i ) + \{ ( max Size ( i ) - min Size ( i ) ) / ( ScaleOutsize ( i ) ) \} * AllowedScaling BV \% ( i ) ] \qquad ( Eq . 2 )$$

$$2 : appBUt Hold ( x ) = ( {\sum }_{k = 1}^{n} if App ( ALT ) = BU ; \{ ( appT Hold ( k ) ) \} ) \qquad ( Eq . 3 )$$

$$3 : appENTt Hold = ( {\sum }_{k = 1}^{n} if App ( ALT ) = ENT ; \{ ( appT Hold ( k ) ) \} ) \qquad ( Eq . 4 )$$

Autoscaling Min size is the minimum computation provisioned for the business. Some embodiments provide a rational mechanism to computer science ontology (CSO), which may be monitored and used to limit the bursting capabilities of a software application from the Max to a desired threshold. In one or more embodiments, a use case for an event of distributed denial of services (DDoS) attack:

$$an organization can save = \{ \sum ( Threshold Scale ) - \sum ( AS Min Scale ) \} \div \{ \sum ( AS Max Scale ) - \sum ( AS Min Scale ) \} \qquad ( Eq . 5 )$$

For this use case, the total saving=79% of compute allocation, which directly impacts the carbon emission saving to the tune of 79%.

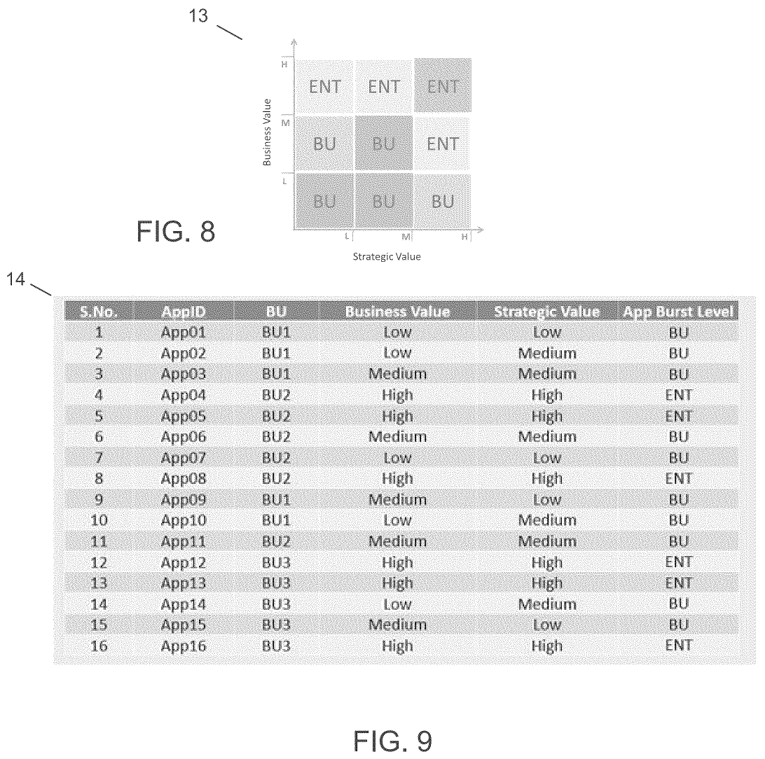

FIG. 8 illustrates a table 13 for a burst value map, according to some embodiments. FIG. 9 illustrates an example table 14 for alignment of applications burst level based on decision rules, according to some embodiments. In one or more embodiments, table 13 decision Rules: ATL are as follows:

| | |
|---|---|
| - | App (ATL) = BU ; if BV = Low . |
| - | App (ATL) = ENT ; if BV = High , |
| - | App (ATL) = ENT if BV = Med & SV= High, else App (ALT) = BU for BV = |
| | Med |

Applications are tagged as BU or ENT based on the above provided rules.

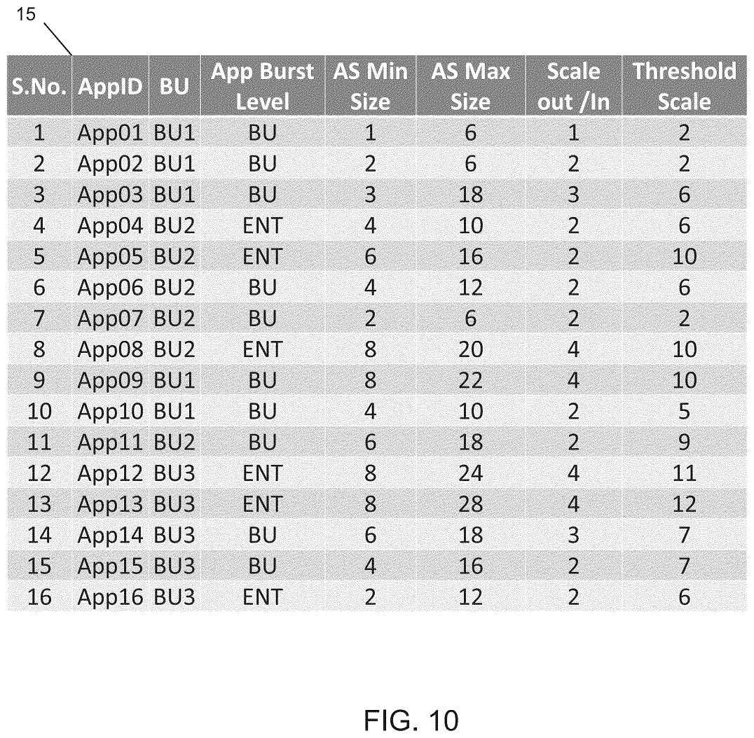

FIG. 10 illustrates an example table 15 for ATL scale, according to some embodiments. In one or more embodiments, table 10 (FIG. 5) is utilized with Eq. 1. For table 15, the algorithm or process used for software application threshold scale follows Eq. 2. Autoscaling Min, Max and Scale-in/out data is taken for an exemplar organization software application threshold scale.

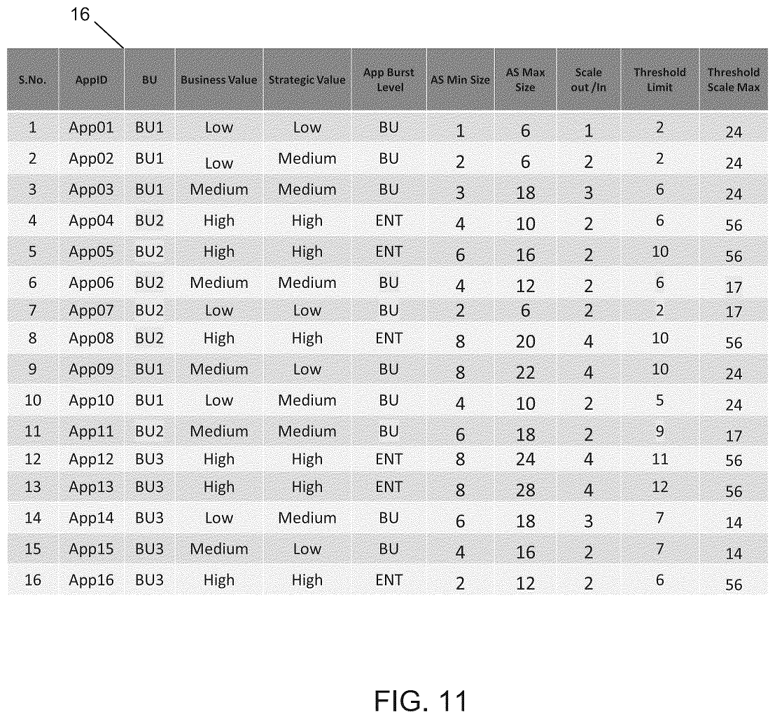

FIG. 11 illustrates an example table 16 for ATL, according to some embodiments. In the event of a DDoS attack, an organization can save=Eq. 5. For this use case, the total saving=79% of compute allocation, which directly impacts the carbon emission saving to the tune of 79%.

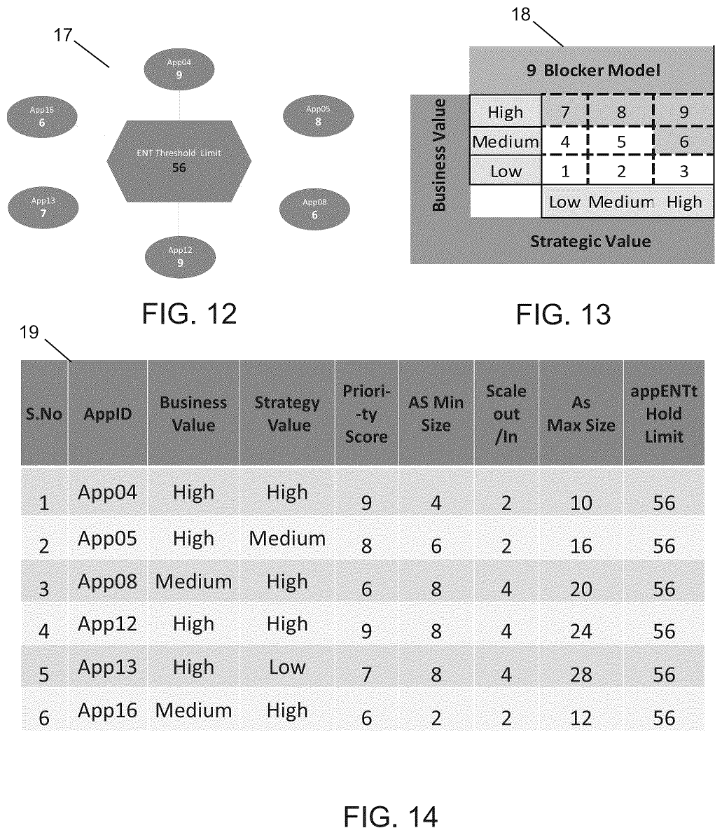

FIG. 12 illustrates an enterprise threshold limit diagram 17, according to some embodiments. FIG. 13 illustrates a table 18 for scaling permitted values for high priorities, according to some embodiments. FIG. 14 illustrates an example table 19 showing high priority score allocation, according to some embodiments. In one or more embodiments, a high table of applications (if App(ALT)=ENT) is established and following two principles is used in determining Application's Burst capacity allocation: high table participating application has claims to ENT Threshold Limit (appENTtHold); and an application with a higher grid rating (e.g., nine (9)) is prioritized to stake a claim (scale out) on the Threshold Limit. In some embodiments, whenever an application (x) starts scaling out, the following processing (e.g., Cloud Function) checks:

1: Determine current consumption across the high table applications, where n is total applications in HT list, m is number of existing scaled out applications, t is times an app has scale out. The algorithm or process used is as follows:

$$CC = ( {\sum }_{n = 1}^{n} AS\_Min \_size ( n ) + {\sum }_{m = 1}^{m} t * AS\_Scaleout \_size ( m ) ) ;$$

2: Check criteria for Application x to scale. Allowance to scale is subjected to its AS_Max_Size and available capacity to scale for its priority score. The algorithm or process used is as follows:

```
      if (CC_New = CC + AS_Min_size(x) ) ≤ (appENTtHold = 56 ) {
          if app_Burst_level(x) ≤ AS_Min_size(x) [
              app_Burst_level_New(x) = app_Burst_level(x) ]
          else if app_Burst_level(x) ≤ AS_Max_size(x) [
            app_Burst_level_New(x) = app_Burst_level(x) + AS_Scaleout_size(x) ]
}
  else { // Check if you need to adjust the Threshold limit and checking priority of
Application
    if (ENT Threshold Limit − CC ) ÷ Max( Range (Scale out/in)) } < 1
        Threshold Limit Adj. = 1.1 * (ENT Threshold Limit) }
        CheckPriority (x).
```

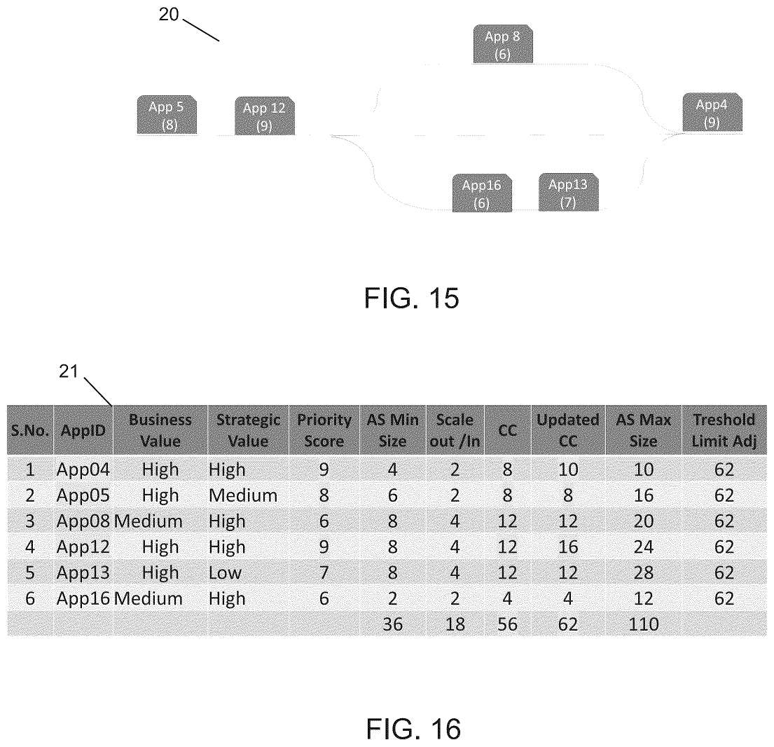

FIG. 15 illustrates an example chart 20 for applications priority access and wait queue mechanism, according to some embodiments. FIG. 16 illustrates an example table 21 for applications burst capacity allocation, according to some embodiments. In one or more embodiments, for chart 20 decision rules, the Application wait que mechanism for fresh scale out and scale in is as follows:
When Current Consumption (CC)≥(appENTtHold=56)
   if appPriority(x)=9; wait=00 Minutes
   if appPriority(x)=8; wait=10 Minutes
   if appPriority(x)=7; wait=20 Minutes
   if appPriority(x)=6; wait=30 Minutes.
      In some embodiments, the algorithm or process used for chart 20 is as follows. For allowing a higher priority application to scale out:

```
For i in range(no. of applications scaled out) : {
    checkPriority (x, i); } // where x is the new application to scale out
    checkPriority (x, i) {
      if appPriority(x) > appPriority(i) && app_Burst_level(x) ≤ AS_Max_size(x) ;
        app_Burst_level_New(x) = app_Burst_level(x) + AS_Scaleout_size(x)
            else
          app_Burst_level_New(x) = app_Burst_level(x)
  // application with low priority is not be allowed to scale out until the load reduces to
  below (appENTtHold = 56 ) and whenever a low priority application scale in a
wait que mechanism is kicked in to allow for a higher priority app to scale. //
          }.
```

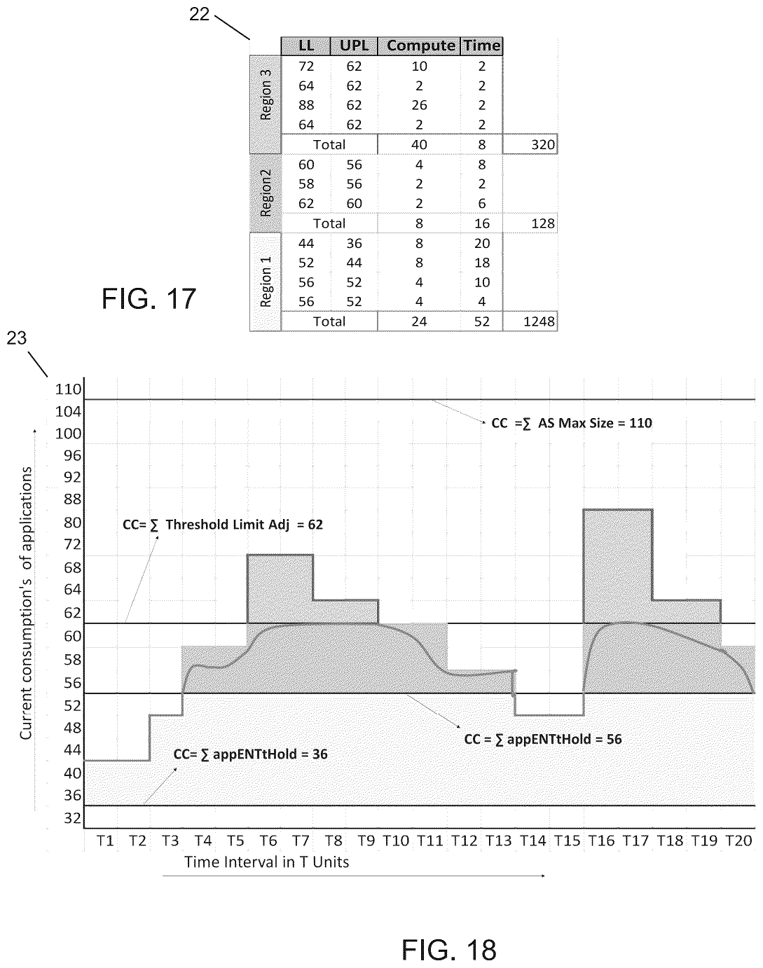

FIG. 17 illustrates an example table 22 for applications compute consumption, according to some embodiments. For the consumption saving from the different regions, the following examples are shown in table 22. Region 3=320 T,

Region 2=15% of 128=19 T. The total % saving of compute power=(saving Region 2+Region 3)÷(total consumption Region 1+Region 2+Region 3=339 T÷1696 T=20% savings).

FIG. 18 illustrates a graph 23 for applications compute consumption over time intervals, according to some embodiments. In one or more embodiments, a 20% reduction in compute consumption may be obtained on normal AS behaviour based on applied que mechanism and priority for applications. The AS_scale max is optimized for a BU, which results in an overall consumption reduction result for a BU level application (maximum scale of the application is reflected on the BU limit). Some embodiments monitor the consumption and burst level for each application, and also in the case where some applications are regularly impacted by not being able to scale out at both BU and SuperBU(ENT) level. Priority of the application leveraging business impact is reviewed. Other adjustments may be increased in processing for Threshold limit %.

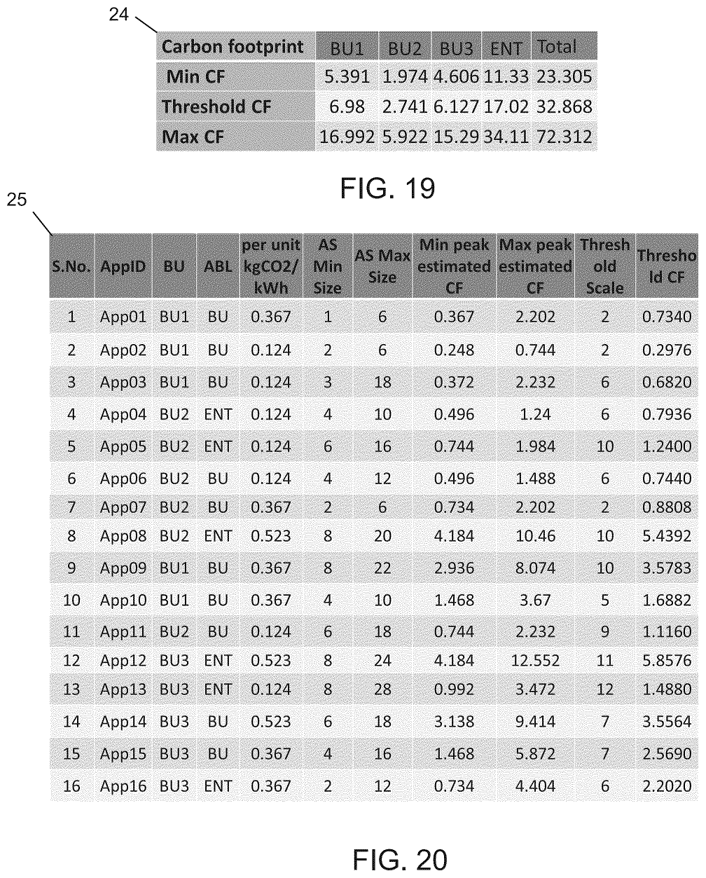

FIG. 19 illustrates a table 24 for carbon footprint (CF) limits, according to some embodiments. FIG. 20 illustrates an example table 25 for application carbon emission threshold, according to some embodiments. Currently, most cloud providers do not track and report carbon emissions from cloud usage to their customers, which can be a challenge for organizations who want to baseline and reduce their carbon footprint. Carbon dioxide equivalent CO2e estimates can be calculated with this formula:

(Cloud provider service usage)×(Cloud energy conversion factors [kWh])×(Cloud provider Power Usage Effectiveness (PUE))×(grid emissions factors [metric tons CO2e]).

In some embodiments, cloud provider service usage: using cloud usage application programming interfaces (APIs) for cloud usage for computing. The energy estimate (Watt-Hours) is determined by:
1: Average Watts=Min Watts+Avg vCPU Utilization*(Max Watts−Min Watts).
2: Compute Watt-Hours=Average Watts*vCPU Hours. Data for Max Watts, Min Watts for computing are published by cloud providers, vCPU Hours from cloud usage APIs. Cloud energy conversion factors [kWh]):
Kilowatt hours=Memory usage (GB-Hours)×Memory coefficient, memory coefficients are provided by cloud providers. For PUEs: a cloud provider publishes PUEs being used: AWS: 1.135, —GCP: 1.1, —Azure: 1.185. Grid emission factor: a cloud provider uses electricity from the grid where the region is located. This electricity generates more or less carbon emissions (gCO2eq), depending on the type of power plants generating electricity for that grid. From table 24: an organization can save CF:

$$CF = \{ \sum ( Threshold CF ) - \sum ( CF Min ) \} \div \{ \sum ( Max CF ) - \sum ( Min CF ) \} .$$

In one or more embodiments, an example use-case may include a total saving equal to 79% of the CF emission, which is directly equivalent to the AS Threshold based compute savings.

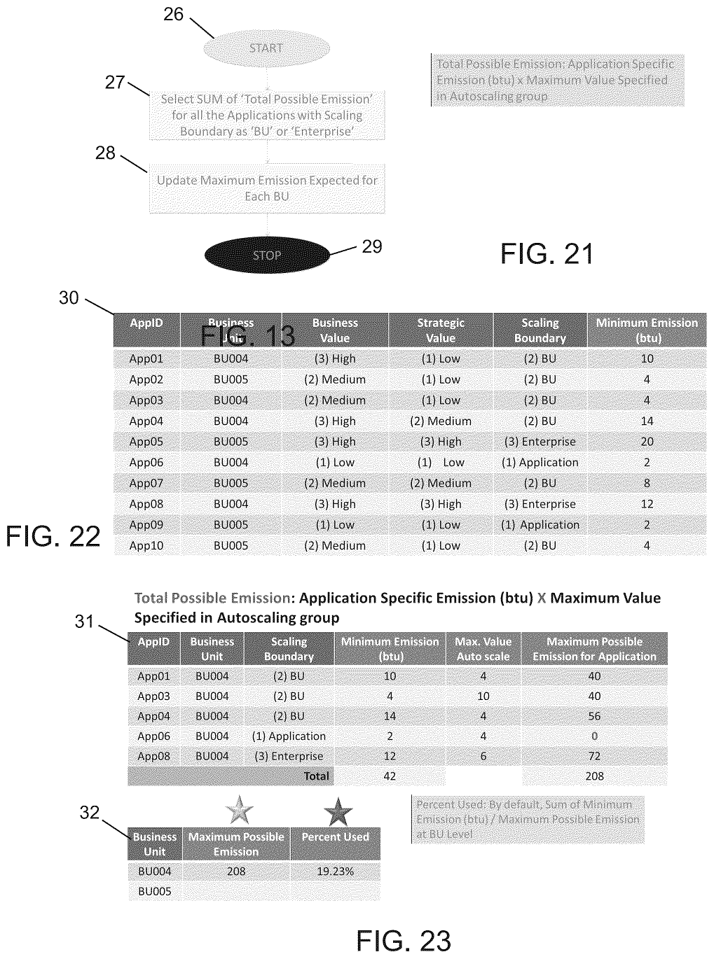

FIG. 21 illustrates a flow diagram for a rule engine for managing maximum emission allowed at the BU level, according to some embodiments. In one or more embodiments, the processing starts at block 26 (START). In block 27, the processing selects a sum of ‘Total Possible Emission’ for all the applications with a scaling boundary as BU or Enterprise. The total possible emission represents: application specific emission (BTU) x Maximum value specified in an autoscaling group. In block 28, the processing updates the maximum emission expected for each BU. The processing ends at block 29 (STOP). FIG. 22 illustrates an example table 30 for BU information, according to some embodiments. FIG. 23 illustrates an example table 31 for BU total possible emission, according to some embodiments. Table 32 shows the percent used by default, Sum of Minimum emission (BTU)/Maximum Possible Emission at the BU level.

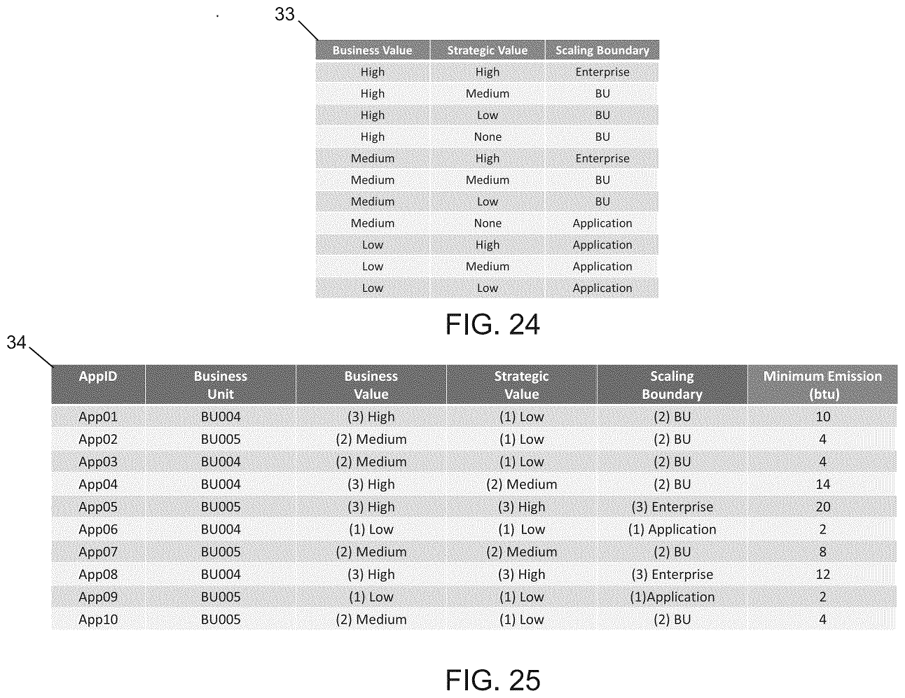

FIG. 24 illustrates a table for scaling boundary, according to some embodiments. In one or more embodiments, the scaling boundary is based on mapping of BV and SV. The scaling boundary is updated through a scheduled job for any changes in BV or SV, either overnight or updates pushed to tags associated with compute resource. A tag is a key-value pair that can be attached to a cloud platform resource.

FIG. 25 illustrates an example table for BU minimum emission (BTU), according to some embodiments. A hyper scaler provides carbon emission for resources allocated to an application for the minimum required compute as per autoscaling rules.

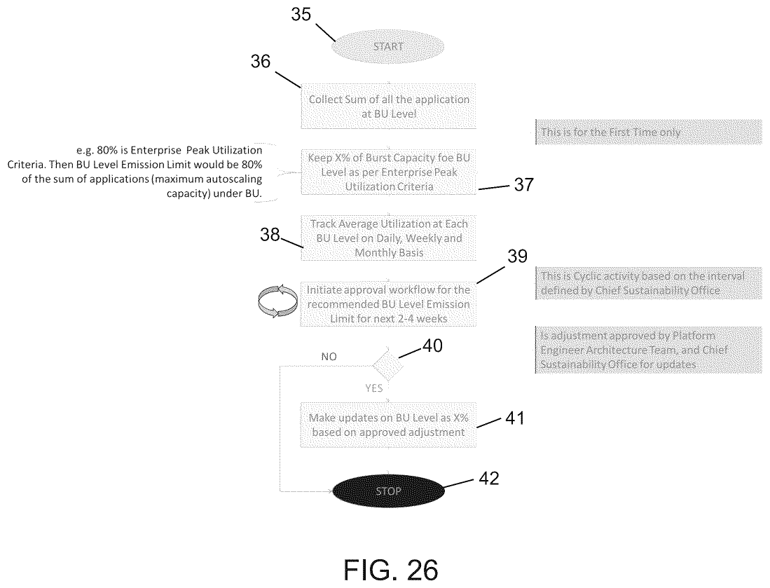

FIG. 26 illustrates another flow diagram for a rule engine for managing maximum emission allowed at the BU level, according to some embodiments. The processing begins with block 35 (START). In block 36, the processing collects a sum of all the application at the BU level. In block 37, the processing keeps X % of burst capacity for the BU level as per enterprise peak utilization criteria. In one example embodiment, for an 80% enterprise peak utilization criteria, the BU level emission limit would be 80% of the sum of applications (maximum autoscaling capacity) under the BU. In block 38, the processing tracks the average utilization at each BU level on a daily, weekly and monthly basis. In block 39, the processing initiates approval workflow for the recommended BU level emission limit for the next 2-4 weeks. This is cyclic activity based on the interval defined by the chief sustainability office. In block 40, it is determined whether adjustment is approved by a platform engineer architecture team and the chief sustainability office for updates. If the determination in lock 40 is No, processing proceeds to block 42 where the processing ends (STOP). Otherwise, processing proceeds to block 41 where updates are made on the BU level as X % based on approved adjustment. Processing then proceeds to block 42.

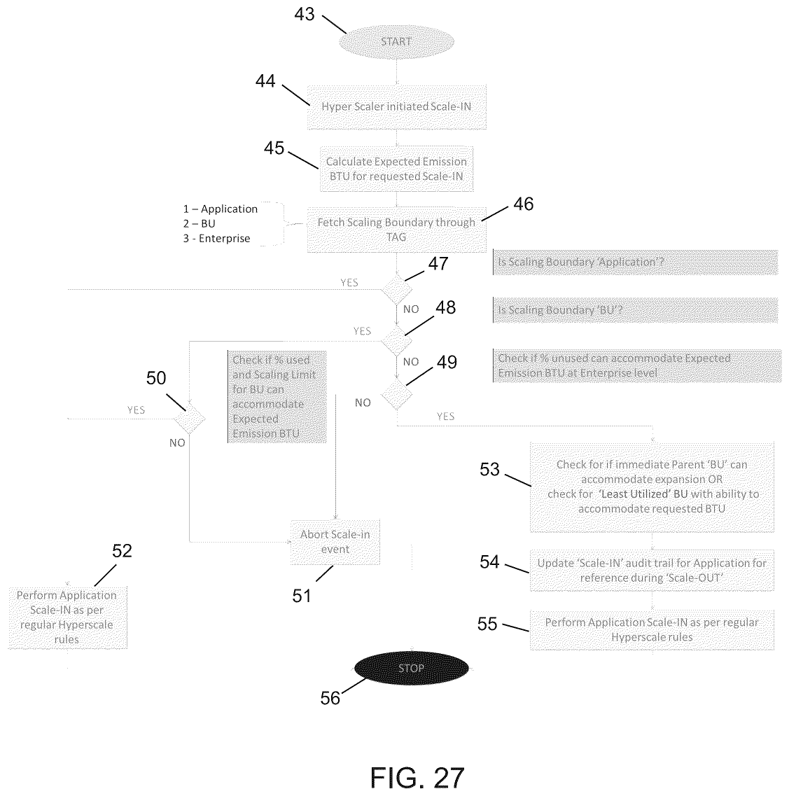

FIG. 27 illustrates a flow diagram for a rule engine for managing BU level scaling limit, according to some embodiments. The processing begins with block 43 (START). In block 44, the processing provides for a hyper scaler to initiate scale-in. In block 45, the processing calculates the expected emission BTU for requested scale-in. In block 46, the processing fetches the scaling boundary through TAG (e.g., 1-Application, 2-BU and 3-Enterprise). In block 47, it is determined whether the scaling boundary is an application. If it is determined that the scaling boundary is an application, the processing proceeds to block 52 where the processing performs an application scale-in as per the regular hyperscale rules. Otherwise, the processing proceeds to block 48 where it is determined whether the scaling boundary is a BU. If the processing determines that the scaling boundary is a BU, the processing proceeds to block 50 where the processing determines if the % used and scaling limit for the BU can accommodate an expected emission BTU. If it is determined that the % used and scaling limit for the BU can accommodate an expected emission BTU, the processing proceeds to block 52. Otherwise, the processing proceeds to block 51 where the scale-in event is aborted; and processing proceeds to block 56 and ends (STOP). If the processing determines in block 48 that the scaling boundary is not a BU, the processing proceeds to block 49. In block 49, the processing determines whether the % unused can accommodate an expected emission BTU as the Enterprise level. If the processing determines that the % unused cannot accommodate an expected emission BTU as the Enterprise level, the processing proceeds to block 51. Otherwise, the processing proceeds to block 53 where the system is checked whether an immediate parent BU can accommodate expansion or it checks for the least utilized BU with the ability to accommodate the requested BU. The processing proceeds to block 54 where the scale-in audit trail for the Application reference during scale-out is updated. The processing proceeds to block 55 where the processing performs an application scale-in as per the regular hyperscale rules. The processing then proceeds to block 56.

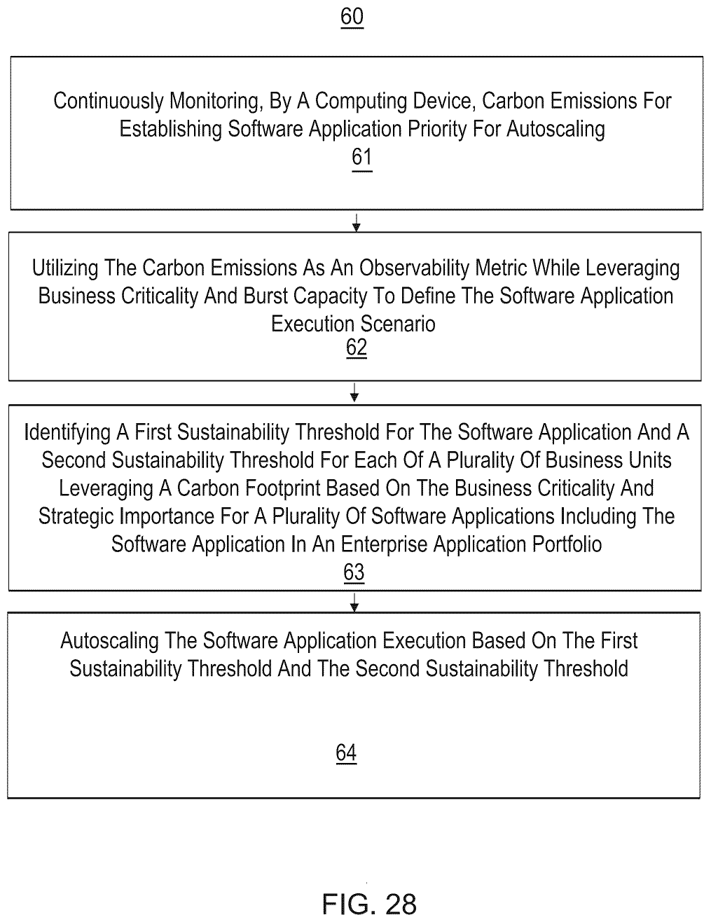

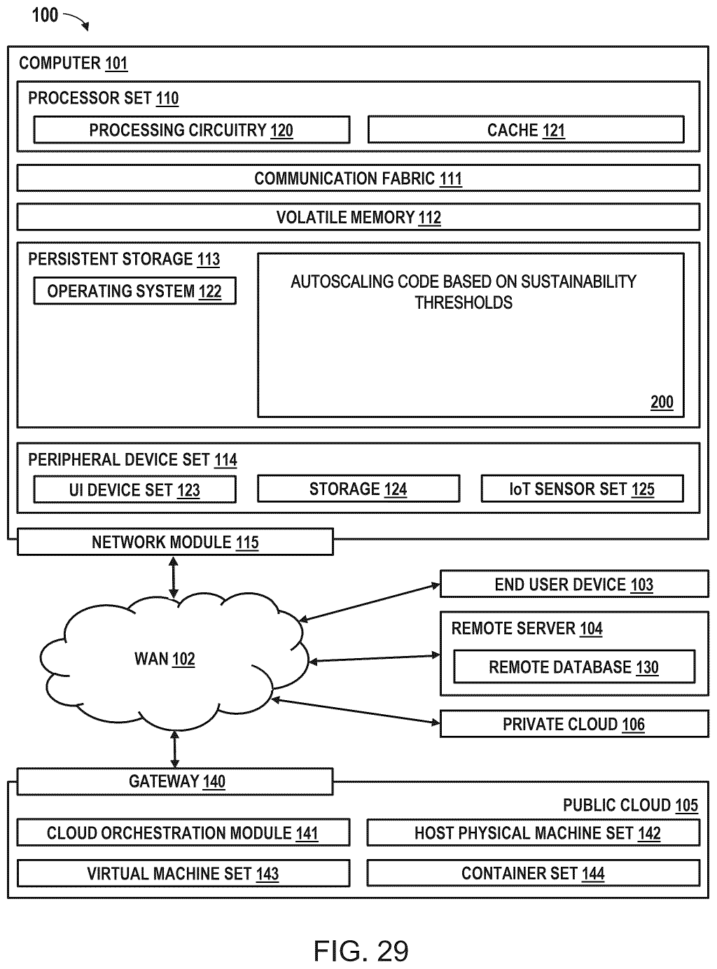

FIG. 28 illustrates a process 60 for autoscaling a software application based on carbon emissions, according to some embodiments. In one embodiment, in block 61 process 60 continuously monitors, using a computing device (using computing environment 100 (FIG. 29), carbon emissions for establishing a software application priority for autoscaling. In block 62, process 60 provides utilizing the carbon emissions as an observability metric while leveraging business criticality and burst capacity to define the software application execution scenario. In block 63, process 60 provides for identifying a first sustainability threshold for the software application and a second sustainability threshold for each of multiple BUs leveraging a carbon footprint based on the business criticality and strategic importance for multiple software applications including the software application in an enterprise application portfolio. In block 64, process 60 provides autoscaling the software application execution based on the first sustainability threshold and the second sustainability threshold.

In some embodiments, process 60 may include the feature of identifying a sustainability index for each application of the multiple software applications.

In one or more embodiments, process 60 may further include the feature of generating an application threshold scale leveraging an autoscaling min, max, scale in and scale out data.

In some embodiments, process 60 may include the feature of establishing an ATL for the multiple software applications.

In one or more embodiments, process 60 may additionally include the feature that the observability metric is utilized within the code of the software application for altering the software application behavior.

In some embodiments, process 60 may further include the feature that the alteration of the software application behavior is performed using the autoscaling based on the carbon emissions.

In one or more embodiments, process 60 may include the feature that continuously monitoring the carbon emissions utilizes APIs from virtual server system providers for monitoring the emissions for each software application of the multiple software applications.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 29 illustrates an example computing environment 100 utilized by one or more embodiments. Computing environment 100 contains an example of an environment for the execution of at least some of the computer code 200 involved in performing the inventive methods (such as autoscaling code based on sustainability thresholds, etc.). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

What is claimed is:

1. A method comprising:
continuously monitoring, by a computing device, carbon emissions for establishing software application priority for autoscaling;
utilizing the carbon emissions as an observability metric while leveraging business criticality and burst capacity to define the software application execution scenario;
identifying a first sustainability threshold for the software application and a second sustainability threshold for each of a plurality of business units leveraging a carbon footprint based on the business criticality and strategic importance for a plurality of software applications including the software application in an enterprise application portfolio; and
autoscaling the software application execution based on the first sustainability threshold and the second sustainability threshold.

2. The method of claim 1, further comprising:
identifying a sustainability index for each application of the plurality of software applications.

3. The method of claim 1, further comprising:
generating an application threshold scale leveraging an autoscaling min, max, scale in and scale out data.

4. The method of claim 3, further comprising:
establishing an application threshold burst level (ATL) for the plurality of software applications.

5. The method of claim 1, wherein the observability metric is utilized within code of the software application for altering the software application behavior.

6. The method of claim 4, wherein the alteration of the software application behavior is performed using the autoscaling based on the carbon emissions.

7. The method of claim 1, wherein continuously monitoring the carbon emissions utilizes application programming interfaces (APIs) from virtual server system providers for monitoring the emissions for each software application of the plurality of software applications.

8. A computer program product for autoscaling a software application based on carbon emissions, the computer program product comprising a computer readable storage medium having program instructions embodied therewith, the program instructions executable by a processor to cause the processor to:
continuously monitor, by the processor, carbon emissions for establishing software application priority for autoscaling;
utilize the carbon emissions as an observability metric while leveraging business criticality and burst capacity to define the software application execution scenario;
identify a first sustainability threshold for the software application and a second sustainability threshold for each of a plurality of business units leveraging a carbon footprint based on the business criticality and strategic importance for a plurality of software applications including the software application in an enterprise application portfolio; and
autoscale the software application execution based on the first sustainability threshold and the second sustainability threshold.

9. The computer program product of claim 8, wherein the program instructions executable by the processor to further cause the processor to:
identify a sustainability index for each application of the plurality of software applications.

10. The computer program product of claim 8, wherein the program instructions executable by the processor to further cause the processor to:
generate an application threshold scale leveraging an autoscaling min, max, scale in and scale out data.

11. The computer program product of claim 10, wherein the program instructions executable by the processor to further cause the processor to:
establish an application threshold burst level (ATL) for the plurality of software applications.

12. The computer program product of claim 8, wherein the observability metric is utilized within code of the software application for altering the software application behavior.

13. The computer program product of claim 12, wherein the alteration of the software application behaviour is performed using the autoscaling based on the carbon emissions.

14. The computer program product of claim 8, wherein continuously monitoring the carbon emissions utilizes application programming interfaces (APIs) from virtual server system providers for monitoring the emissions for each software application of the plurality of software applications.

15. An apparatus comprising:
a memory configured to store instructions; and
a processor configured to execute the instructions to:
continuously monitor carbon emissions for establishing software application priority for autoscaling;
utilize the carbon emissions as an observability metric while leveraging business criticality and burst capacity to define the software application execution scenario;
identify a first sustainability threshold for the software application and a second sustainability threshold for each of a plurality of business units leveraging a carbon footprint based on the business criticality and strategic importance for a plurality of software applications including the software application in an enterprise application portfolio; and
autoscale the software application execution based on the first sustainability threshold and the second sustainability threshold.

16. The apparatus of claim 15, wherein the processor is further configured to execute the instructions to:
identify a sustainability index for each application of the plurality of software applications.

17. The apparatus of claim 15, wherein the processor is further configured to execute the instructions to:
generate an application threshold scale leveraging an autoscaling min, max, scale in and scale out data.

18. The apparatus of claim 17, wherein the processor is further configured to execute the instructions to:
establish an application threshold burst level (ATL) for the plurality of software applications.

19. The apparatus of claim 15, wherein the observability metric is utilized within code of the software application for altering the software application behaviour.

20. The apparatus of claim 19, wherein:
the alteration of the software application behaviour is performed using the autoscaling based on the carbon emissions; and
continuously monitoring the carbon emissions utilizes application programming interfaces (APIs) from virtual server system providers for monitoring the emissions for each software application of the plurality of software applications.
